(19) United States
(12) Patent Application Publication
(10) Pub. No.: US 2003/0234067 A1
(43) Pub. Date: Dec. 25, 2003

(54) Rubber composition and tire using the same

(76) Inventors: Takahiro Kataoka, Kobe-shi (JP); Kunihiko Shimizu, Osaka (JP)

Correspondence Address: BIRCH STEWART KOLASCH & BIRCH, PO BOX 747, FALLS CHURCH, VA, 22040-0747, US

(21) Appl. No.: 10/449,391

(22) Filed: Jun. 2, 2003

(30) Foreign Application Priority Data
Jun. 21, 2002 (JP) 2002-180873

(51) Int. Cl. B60C 1/00; B60C 13/00; C08J 3/20

(52) U.S. Cl. 152/525; 524/1

(57) ABSTRACT

A rubber composition is disclosed that contains 5 to 100 phr of a bloom compound, 30 to 100 phr of a white filler, and at most 10 phr of a black filler, wherein the bloom compound preferably contains at least one compound selected from the group consisting of an aromatic amine compound, an aliphatic compound, and an organometallic compound. A tire using the rubber composition for a tread portion and/or a sidewall portion of the tire is also disclosed.

### BACKGROUND OF THE INVENTION

1. Field of the Invention

The present invention relates to a rubber composition and a tire using the same. More specifically, the present invention relates to a rubber composition having a vivid color to improve the appearance of a rubber product, and to a tire using the same.

2. Description of the Background Art

Conventionally, in rubber products such as tires, a black filler such as carbon black has been used as a reinforcing agent. The black filler such as carbon black is indispensable as a reinforcing agent for rubber products, but the rubber product using the black filler becomes black.

In addition, there are some cases where a wax, an aromatic amine compound or the like is blended into the rubber product to prevent the occurrence of cracks. By the blooming of such a wax or the like on the surface of the rubber product, a thin film is formed on the surface, preventing the occurrence of cracks in the rubber product caused by the action of ozone in the air, sunlight, or the like.

However, the above-mentioned black rubber product has a problem that it lacks variations in its appearance. To provide variations to the appearance of the black rubber product, a coloring agent is mixed into the rubber product, or a design is printed on the surface of the rubber product. Still, the above problem has not been solved sufficiently.

When the wax, the aromatic amine compound or the like blooms on the surface of the rubber product, the rubber product looks as if it takes on a color which derives from the color of the wax or the like. However, since the rubber product contains such a wax or the like only in an amount sufficient to prevent the occurrence of cracks, even if the rubber product takes on a color, it appears as if it just becomes dirty.

### SUMMARY OF THE INVENTION

In view of the foregoing, it is an object of the present invention to provide a rubber composition having a vivid color to improve the appearance of a rubber product, and a tire using the same.

To achieve the above object, the inventors of the present invention have found that color development of a rubber product becomes possible by utilizing the blooming of a wax, an aromatic amine compound or the like, and that the appearance of the rubber product can be improved by using the proper content of the wax, the aromatic amine compound or the like, thus conceiving the present invention.

The present invention provides a rubber composition containing 5 to 100 parts per hundred rubber (phr) of a bloom compound, 30 to 100 phr of a white filler, and at most 10 phr of a black filler.

Here, in the rubber composition of the present invention, the bloom compound preferably contains at least one compound selected from the group consisting of an aromatic amine compound, an aliphatic compound, and an organometallic compound.

The rubber composition of the present invention preferably contains 20 to 80 phr of the aromatic amine compound, 1 to 25 phr of the aliphatic compound, and at most 10 phr (including 0 phr) of the organometallic compound.

The rubber composition of the present invention preferably contains at most 5 phr of the aromatic amine compound, 30 to 90 phr of the aliphatic compound, and at most 5 phr (including 0 phr) of the organometallic compound.

The rubber composition of the present invention preferably contains at most 5 phr of the aromatic amine compound, at most 30 phr of the aliphatic compound, and 20 to 65 phr of the organometallic compound.

Further, the present invention is a tire using the rubber composition described above for at least one of a tread portion and a sidewall portion of the tire.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section of one example of the tire in accordance with the present invention.

### DESCRIPTION OF THE PREFERRED EMBODIMENTS

An embodiment of the present invention will be described in the following.

Rubber Component

A conventionally known rubber component can be used as the rubber component in the present invention, and it is preferable to use one or more of a polyolefin rubber component and/or a diene rubber component.

As the polyolefin rubber component, for example, a rubber component such as ethylene-propylene copolymer (EPR), ethylene-propylene-diene terpolymer (EPDM), isobutylene-isoprene rubber (IIR), chlorinated polyethylene rubber (CM), or chlorosulfonyl polyethylene rubber (CSM) can be used. As the diene rubber component, for example, a rubber component such as natural rubber (NR), butadiene rubber (BR), styrene-butadiene rubber (SBR), or isoprene rubber (IR) can be used.

In addition, other rubber can be used in combination with the rubber component for use in the present invention, as long as it does not impair the effects obtained by the present invention. As the other rubber that can be used in combination with the rubber component of the present invention, one or more of acrylonitrile-butadiene rubber (NBR), hydrogenated NBR in which the unsaturated bond portion of the NBR is hydrogenated, acrylic rubber (ACM), epichlorohydrin rubber (CO), or polynorbornene rubber (NOR), or the like can be used.

Bloom Compound

A bloom compound refers to a compound which exudes on the surface of a rubber product due to heat emission or the like of the rubber product, some time after production of the rubber product.

5 to 100 phr of the bloom compound is contained. When the content of the bloom compound is less than 5 phr, the content of the bloom compound is so small that the rubber product may not develop a color. When the content of the bloom compound is more than 100 phr, physical properties of the rubber product such as strength and durability tend to be deteriorated.

The bloom compound for use in the present invention preferably contains at least one compound selected from the group consisting of an aromatic amine compound, an aliphatic compound, and an organometallic compound. In this case, the rubber product tends to have a more vivid color.

Here, examples of the possible aromatic amine compound are N-phenyl-N′-isopropyl-p-phenylenediamine, N-(1,3-dimethyl butyl)-N′-phenyl-p-phenylenediamine, aldol-α-naphthylamine, octylated diphenylamine, phenyl-isopropyl-p-phenylenediamine, N-phenyl-N′-(1-methyl heptyl)-p-phenylenediamine, N-phenyl-N′-(1,3-dimethyl butyl)-p-phenylenediamine, N-N′di(1,4-dimethyl pentyl)-p-phenylenediamine, or diallyl-p-phenylenediamine.

Examples of the possible aliphatic compound are paraffine wax, micro wax, polyethylene wax, or oxide, fluoride, or chloride thereof An example of the possible organometallic compound is cobalt stearate.

Preferably, 20 to 80 phr of the aromatic amine compound, 1 to 25 phr of the aliphatic compound, and at most 10 phr (including 0 phr) of the organometallic compound are contained. In this case, vivid brown is exhibited, which can further improve the appearance of the rubber product.

Preferably, at most 5 phr of the aromatic amine compound, 30 to 90 phr of the aliphatic compound, and at most 5 phr (including 0 phr) of the organometallic compound are contained. In this case, vivid white is exhibited, which can further improve the appearance of the rubber product.

Preferably, at most 5 phr of the aromatic amine compound, at most 30 phr of the aliphatic compound, and 20 to 65 phr of the organometallic compound are contained. In this case, vivid blue is exhibited, which can further improve the appearance of the rubber product.

Further, the rubber product can be colored in, for example, green, red, or purple, by appropriately changing the content and the material property of the bloom compound.

White Filler

As the white filler for use in the present invention, one or more of silica, clay, alumina, talc, calcium carbonate, magnesium carbonate, aluminum hydroxide, magnesium hydroxide, magnesium oxide, titanium oxide, or the like can be used. 30 to 100 phr, preferably 30 to 60 phr of the white filler is contained. When the content of the white filler is less than 30 phr, reinforcement would be insufficient. When the content of the white filler is more than 100 phr, processability tends to be deteriorated.

Black Filler

Though the black filler for use in the present invention is not particularly limited as long as it is generally used as a reinforcing agent for rubber, examples may include one or more kinds of carbon black such as channel black, furnace black, acetylene black, or thermal black. At most 10 phr, preferably at most 5 phr of the black filler is contained. When the content of the black filler is more than 10 phr, development of a beautiful color is not likely.

Other Additives

In the present invention, in addition to the materials described above, additives such as a plasticizer, a vulcanizing agent, an accelerator activator, a vulcanization accelerator, or the like can be blended as necessary. Examples of the possible plasticizer include dioctyl phthalate, dibutyl phthalate, dioctyl sebacate, dioctyl adipate, or the like. Examples of the possible vulcanizing agent include organic peroxide such as benzoyl peroxide, dicumyl peroxide, or di-tert-butyl peroxide, or sulfur. Examples of the possible accelerator activator include zinc oxide or stearic acid. Examples of the possible vulcanization accelerator include a thiazole type accelerator such as 2-mercaptobenzothiazole or dibenzothiazyl disulfide, a sulfen amide type accelerator such as N-tert-butyl-2-benzothiazolyl sulfen amide or N-cyclohexyl-2-benzothiazolyl sulfen amide, or a guanidine type accelerator such as diphenylguanidine. 0 to 100 phr of these additives are blended.

Method for Manufacturing the Rubber Composition

The rubber composition in accordance with the present invention can be manufactured using a conventionally known method. For example, in one method, the materials described above are each weighed so as to obtain predetermined blend proportions, then mixed using a mixer such as an open roll or a Banbury mixer for 5 to 60 minutes at 100 to 250 degrees centigrade.

Application of the Rubber Composition

The rubber composition in accordance with the present invention can be used for conventionally known rubber products such as tires, belts, hoses, rubber footwear, erasers, or rubber rolls. In particular, it is suitably used for tires such as pneumatic tires and solid tires.

Tire

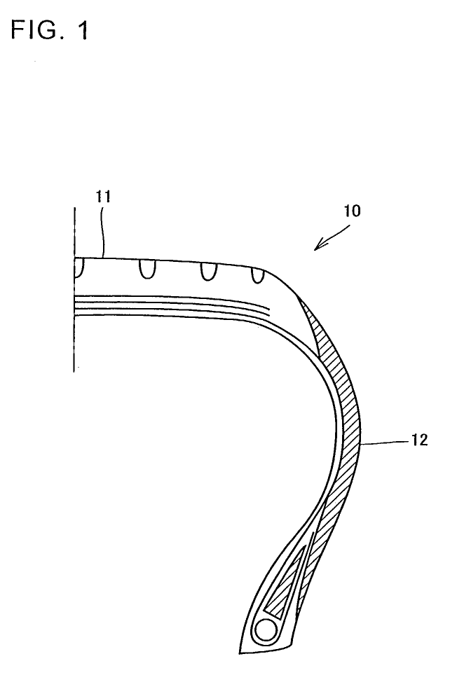

The tire in accordance with the present invention is preferably formed using the rubber composition described above for a tread portion and/or a sidewall portion of the tire. FIG. 1 shows a schematic cross section of one preferred example of the tire in accordance with the present invention. In FIG. 1, a tire 10, which is symmetrical with respect to a tread portion 11 having a contact area and grooves, is provided with a sidewall portion 12 on its side. As shown in FIG. 1, tread portion 11 and sidewall portion 12 define the appearance of tire 10. Thus, when the rubber composition described above is used for tread portion 11 and/or sidewall portion 12 of tire 10, heat emission or the like at tread portion 11 and sidewall portion 12 generated through the use of tire 10 causes the bloom compound to exude from the surface of tread portion 11 and/or sidewall portion 12, and cover the surface. Accordingly, tire 10 comes to have a vivid color, which can improve the appearance of tire 10.

In addition, even when the surface of tread portion 11 or sidewall portion 12 is scratched by a plant, for example, and the bloom compound covering the surface is scraped off, the bloom compound comes to exude again on the surface, because it is contained in the rubber composition forming the tread portion 11 or sidewall portion 12. Thus, tire 10 still can come to have a color.

In view of the susceptibility to scratch, it is more preferable that the rubber composition described above is used only for sidewall portion 12. Further, when rubber sheets having different colors are pasted on respective portions such as tread portion 11 and sidewall portion 12, the portions constituting the tire can have various colors. Therefore, the tire in accordance with the present invention can have more improved appearance.

Application to the Tire

The tire in accordance with the present invention can be used for applications which are not particularly limited, and it can suitably be used for a conventionally known application such as a monocycle, an automobile such as a two-wheeled, three-wheeled, or four-wheeled vehicle, vehicles such as a motorcycle, a bus, or a truck, an aircraft such as a jet plane, or the like. Particularly, since the tire in accordance with the present invention can have a vivid camouflage color, it can suitably be used for an ATV (All Terrain Vehicle), a jeep, an RV (Recreational Vehicle), or the like.

### EXAMPLES

In the following, the present invention will be described by way of examples. It should be noted that the present invention is not limited to the description below.

Preparation of Samples

i) Preparation of Rubber Compositions

Materials were weighed so as to obtain the blend proportions shown in Table 1, and mixed using a Banbury mixer so as to be uniformly distributed, to prepare rubber compositions of Examples 1-3 and Comparative Examples 1-2. Note that the blend proportions of the materials shown in Table 1 represent values by phr formed by mixing butadiene rubber and styrene-butadiene rubber.

ii) Preparation of Tires

Rubber sheets were prepared using the rubber compositions of Examples 1-3 and Comparative Examples 1-2, pasted on sidewall portions of tires, and vulcanized at 145 degrees centigrade for 40 minutes, to prepare tires of Examples 1-3 and Comparative Examples 1-2.

Evaluation Method

The tires of Examples 1-3 and Comparative Examples 1-2 were left outdoors for 30 days to check the types of colors appeared on the tires and further to evaluate the appearances of the tires. Table 1 shows the result of the evaluation. Note that the appearances of the tires were evaluated based on the following criteria.

\mathring{◯} The tire had a very beautiful appearance.

◯ The tire had a beautiful appearance.

Δ The appearance of the tire was not so beautiful.

TABLE 1

| | | Examples | | | Comparative Examples | |
|---|---|---|---|---|---|---|
| | | 1 | 2 | 3 | 1 | 2 |
| Rubber Blend | BR (*1) | 50 | 50 | 50 | 50 | 50 |
| proportions | SBR (*2) | 50 | 50 | 50 | 50 | 50 |
| | zinc oxide (*3) | 3 | 3 | 3 | 3 | 3 |
| | stearic aoid (*4) | 2 | 2 | 2 | 2 | 2 |
| | sulfur (*5) | 2 | 2 | 2 | 2 | 2 |
| | vulcanization | 1.5 | 1.5 | 1.5 | 1.5 | 1.5 |
| | accelerator (*6) | | | | | |
| | carbon black (*7) | 5 | 5 | 5 | 5 | 5 |
| | silica (*8) | 50 | 50 | 50 | 50 | 50 |
| | 6PPD (*9) | 30 | 1 | 1 | 1 | 1 |
| | paraffine wax (*10) | 20 | 50 | 20 | 1 | 1 |
| | cobalt complex | — | — | 30 | — | 1 |
| | (*11) | | | | | |
| Evaluation | appeared color | brown | white | blue | not colored | not colored |
| | tire appearance | ⊚ | ⊚ | ⊚ | — | — |

(*1) butadiene rubber (“BR-15” produced by JSR Corporation)
(*2) stylene-butadiene rubber (“SBR1502” produced by Nippon Zeon Co., Ltd.)
(*3) “Zinc Oxide Type 2” produced by Mitsui Mining & Smelting Co., Ltd.
(*4) “Stearic Acid Tsubaki” produced by NOF Corporation
(*5) “Sulfur” produced by Karuizawa Smelter
(*6) “Nocceler CZ”produced by Ouchi Shinko Chemical Industrial Co., Ltd.
(*7) “Seast 3” produced by Tokai Carbon Co., Ltd.
(*8) “VN3” produced by Degussa AG
(*9) N-(1,3-dimethyl butyl)-N′-phenyl-p -phenylenedliamine (“Antigene 6C” produced by Sumitomo Chemical Co., Ltd.)
(*10) “Ozoace” produced by Nippon Seiro Co., Ltd.
(*11) “Cobalt Stearate” produced by Dainippon Ink and Chemicals, Incorporated

Result of Evaluation

As can be seen from Table 1, the tires of Examples 1-3 were all well-colored, and all of them had very beautiful appearances. The tires of Comparative Examples 1-2, however, were not colored.

As has been described above, in accordance with the present invention, a rubber composition having a vivid color to improve the appearance of a rubber product, and a tire using the same can be provided.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A rubber composition containing 5 to 100 phr of a bloom compound, 30 to 100 phr of a white filler, and at most 10 phr of a black filler.

2. The rubber composition according to claim 1, wherein the bloom compound contains at least one compound selected from the group consisting of an aromatic amine compound, an aliphatic compound, and an organometallic compound.

3. The rubber composition according to claim 2, wherein the rubber composition contains 20 to 80 phr of the aromatic amine compound, 1 to 25 phr of the aliphatic compound, and at most 10 phr of the organometallic compound.

4. The rubber composition according to claim 2, wherein the rubber composition contains at most 5 phr of the aromatic amine compound, 30 to 90 phr of the aliphatic compound, and at most 5 phr of the organometallic compound.

5. The rubber composition according to claim 2, wherein the rubber composition contains at most 5 phr of the aromatic amine compound, at most 30 phr of the aliphatic compound, and 20 to 65 phr of the organometallic compound.

6. A tire using the rubber composition according to claim 1 for at least one of a tread portion and a sidewall portion of the tire.
